(19) United States
(12) Patent Application Publication
(10) Pub. No.: US 2009/0178718 A1
(43) Pub. Date: Jul. 16, 2009

(54) VALVE FOR A TANK, IN PARTICULAR A MOTOR VEHICLE FUEL TANK

(76) Inventor: Xavier Nast, Colmar (FR)

Correspondence Address: MOORE & VAN ALLEN PLLC, P.O. BOX 13706, Research Triangle Park, NC, 27709, US

(21) Appl. No.: 11/995,637

(22) PCT Filed: Jul. 14, 2006
(86) PCT No.: PCT/EP2006/006927

§ 371 Date: Dec. 23, 2008

(30) Foreign Application Priority Data
Jul. 15, 2005 (FR) 05/07558

(51) Int. Cl. F16K 24/04

(52) U.S. Cl. 137/197

(57) ABSTRACT

The invention concerns a valve for a tank, in particular a motor vehicle fuel tank, with an input, an output and an input and output connecting fluid communication used for flowing out of the tank and flowing into the reservoir of a fluid in gaseous state, such as air and/or a fuel in gaseous state, and having a mechanism for separating the fluid communication capable of being activated depending on the position of the tank and comprising at least one mobile closure element (9) capable of being moved between a passive open position and an active position interrupting the fluid communication and wherein the passage of a fluid, in particular at least one liquid such as a liquid fuel, through the fluid communication is substantially interrupted, it is provided that the separating mechanism includes at least one automatic control element, structurally separated from the at least one closure element (9).

The present invention concerns a valve for a tank, in particular a fuel tank for a motor vehicle, with an input, an output and a fluid communication connecting the input and the output and serving for the flowing out of the tank and the flowing into the tank of a fluid in a gaseous state, such as air and/or a fuel in gaseous state.

Such a valve, which comprises a closure element, the force of which supplied by the weight acts against a spring, is known by the document EP 0 976 597 B1. A ball which allows a passage of gas when a certain internal pressure has been exceeded is provided over an opening. The known valve presents the disadvantage of a great height which causes loss of volume of the tank for its being filled with fuel. Furthermore, the known valve presents a leakage when the tank is greatly inclined or is turned over, which is the case if, in an emergency situation, a motor vehicle with a filled tank is overturned on its roof or on its side.

Moreover, it is known to use floating bodies as valves which can close a passage opening in the case of a change to the level of liquid.

The object of the invention is to propose a valve for a tank, in particular for a fuel tank for a motor vehicle, in the case where a flow of liquid via the valve is likewise avoided when the valve arrives into an emergency inclined position with respect to the normal horizontal position, when the placing of the valve only leads to the smallest possible loss with regard to the filling volume of the tank.

The solution according to the invention to achieve this objective lies in the characteristics first claimed.

According to these characteristics, the valve according to the invention is provided with a mechanism for the separation of the fluid communication, which can be activated depending on the position of the tank or of the valve and comprises at least one mobile closure element which can be moved between a passive open position and an active position which interrupts the fluid communication between the input and the output and in which a passage of a fluid, in particular of a liquid such as a liquid fuel, through the fluid communication is substantially interrupted. The separation mechanism comprises, in accordance with the invention, at least one actuator or a control or positioning element which is structurally separated from the said at least one closure element and which can be activated in the three-dimensional volume as a function of the position of the tank or of the valve to transfer to the closure element a closure force serving to control or to position the closure element so as to move it from the passive position to the active position.

Due to the step according to the invention consisting in providing an actuator which is structurally separated from the closure element, it is possible to distribute over several components the task which is usually incumbent upon a single component and which consists in producing the necessary closure forces. It is thus possible to conceive the valve carrying out the set function described above according to a flat shape, i.e. inside a narrow volume band in the zone of the wall of the tank. In the volume band there are, likewise, in addition to the closure element, the actuator, in particular several actuators providing the control function. The distribution according to the invention over several control elements or actuators of the production function of the closure force guarantees in a secure manner that a sufficient closure force acts constantly on the closure element, this being the case whatever the emergency functioning position in which the valve according to the invention is situated.

In the case of a preferred form of embodiment of the invention, several control elements or actuators are associated with a closure element in such a way that with respectively a predetermined position of the tank in the three-dimensional volume, at least one of the control elements or actuators, preferably two control elements or actuators transmit a closure force to the closure element. According to the invention, a sufficient number of control elements or actuators should be implemented so that, in every possible position, in particular in the emergency functioning position of the tank, therefore for example when the motor vehicle with the fuel tank is in a lateral inclined position or is turned over, at least one of the control elements or actuators is able to bring about the closure of the closure element. The several actuators can then be connected with each other in such a way that, for positions of the tank or of the valve in the three-dimensional volume which can be predetermined in different ways, at least one actuator, preferably a pair of actuators, is activated, so that a closure force is transmitted to the closure element.

In the case of a development of the invention, the at least one actuator is designed to transmit the closure force to the closure element in an autonomous manner, i.e. without additional activation energy. The actuator then becomes active in an autonomous manner to transmit the closure force to the closure element when it arrives into a predetermined position or into a predetermined zone of positions. The automatic activity of the actuator can be realized by the fact that stresses provided by the weight of the bodies of the control elements, when a position being able to be predetermined is reached, are guided and oriented in such a way that a closure force directed to the closure element comes into action.

In the case of a development of the invention, the at least one actuator is deactivated in a normal functioning mode in which the tank, in particular the motor vehicle, is in a substantially horizontal position. Horizontal position should be understood to mean the position of the tank or of the valve in which a vertical line of the tank coincides substantially with the direction of gravitation. Furthermore, the at least one actuator can, in an emergency functioning mode in which the tank, in particular the motor vehicle, is in an oblique position substantially tilted and/or inclined with respect to the horizontal position, transmit to the closure element a closure force to bring the closure element into an active position.

Preferably at least two control elements, preferably at least three control elements, preferably at least four control elements, preferably at least six control elements, preferably at least eight closure elements, in particular nine control elements are provided for a closure element. The more control elements are used, the more the functioning mode of the valve becomes secure which consists in acting on the closure element with a sufficient closure force in each emergency functioning position.

In the case of an inclination of the valve or of the tank with respect to a vertical axis, which is in particular directed in the direction parallel to the direction of gravitation, in particular to the direction of terrestrial gravitation, i.e. with an angle of inclination with respect to this axis of 5° to 90°, the inclination being able to take place in all the horizontal directions, it is possible to activate a group of at least four control elements, preferably a group of four pairs of control elements, when at least one of the control elements, preferably one of the pairs of control elements, is activated automatically such that a closure force for the control of the closure element so as to move it into the active position is transmitted to the closure element. In the case of an inclination of the valve or of the tank around the vertical axis, i.e. with an angle of inclination of 90° to 180° in all the horizontal directions, at least two control elements can be activated.

In the case of a preferred development of the invention, the at least one actuator is formed, in particular for an inclination with an angle of 5° to 90° around a vertical axis, by at least one movable metallic ball, preferably by a pair of movable metallic balls, which metallic ball, when the valve is inclined, is guided under the influence of the stress provided by its weight along a cam path from a position of rest to an entrainment position, when on the passage of the cam path the metallic ball provides a closure force to the closure element. At least one part of the cam path can then be formed by the closure element, which assigns a starting slope to each metallic ball.

The at least one metallic ball is preferably housed in a movable manner in a valve case which defines at least partially the cam path.

In the case of a development of the invention, a main passage opening, through which all the connecting lines or conduits extend from the input to the output, can be provided. In this way, it is guaranteed that all the fluid passage channels must pass the main passage opening, passing through the valve. To guarantee a sure closure of the valve or a separation of the fluid communication between the input and the output, it is sufficient that a closure element is assigned to the main passage opening.

In the case of a development of the invention, the at least one closure element comprises a tightness section which, in the active position of the closure element, is formed for the closure of a passage opening of the fluid communication, which passage opening is configured in particular in a valve case containing in a movable manner the closure element.

In the zone of the passage opening, a flexible tightness ring is preferably arranged which, in the active position of the closure element, receives the tightness section by forming a tightness surface extending substantially over the entire periphery.

The at least one closure element is preferably configured as a floating body for a liquid contained in the tank.

An aspect of the invention which is autonomous and which also depends on the objective explained above concerns a valve which is intended to be mounted in a motor vehicle tank and which comprises a device to produce a rapid rise of overpressure in the tank. The device comprises a group of at least two valve bodies which, at least when the vehicle is in a stopped position, occupy, so as to ensure its tightness, respectively a passage in the fluid communication formed by the valve case. The device further comprises a valve element to occupy a bypass or diversion for the passage formed by the valve case, the valve element being adjusted in such a way as regards its weight that in the case of a predetermined overpressure being exceeded inside the tank, it occupies substantially the bypass at the same time.

With this aspect of the invention, the basic idea is likewise used, consisting in distributing functions over several components, which are at least two valve bodies here. The distribution of the functions allows the flat design of the valve which is desired, and this being even in the case of supplementary integration of the device to produce a rapid rise in overpressure.

The at least two valve bodies are preferably formed by metallic balls having substantially identical masses. Four valve bodies can be assigned to four passages.

Other properties, characteristics and advantages of the invention will become clear with the following description of a preferred form of embodiment of the invention which is made on the basis of the attached drawings. The figures show:

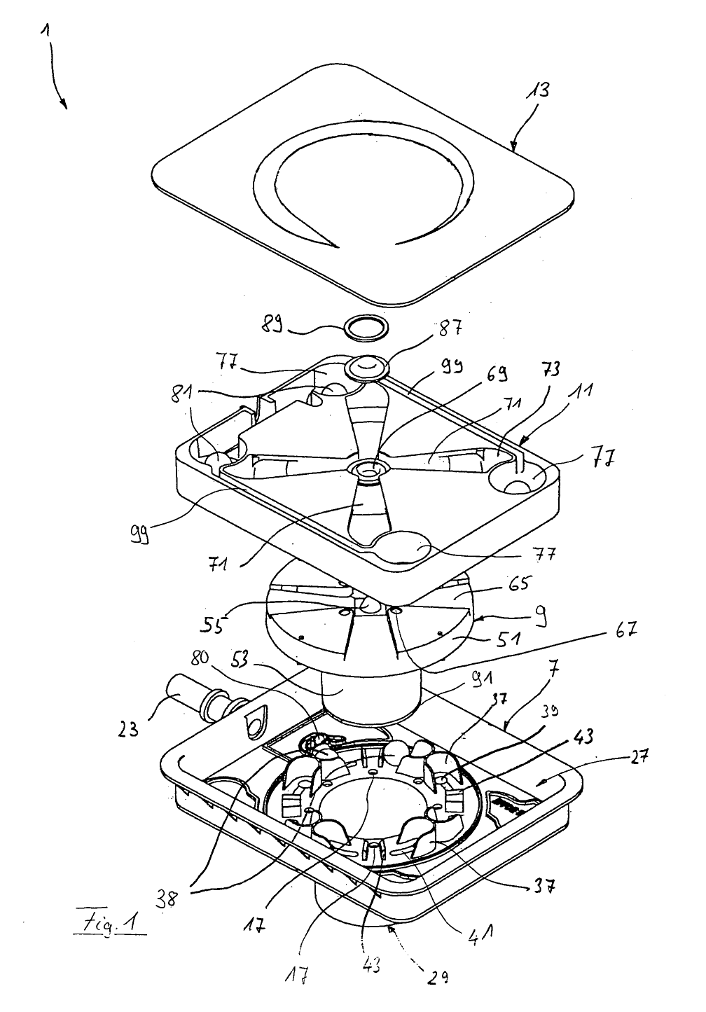

FIG. 1: an exploded view in perspective of the valve according to the invention;

FIG. 2: an exploded illustration in perspective with a view in transverse section of the valve according to the invention of FIG. 1;

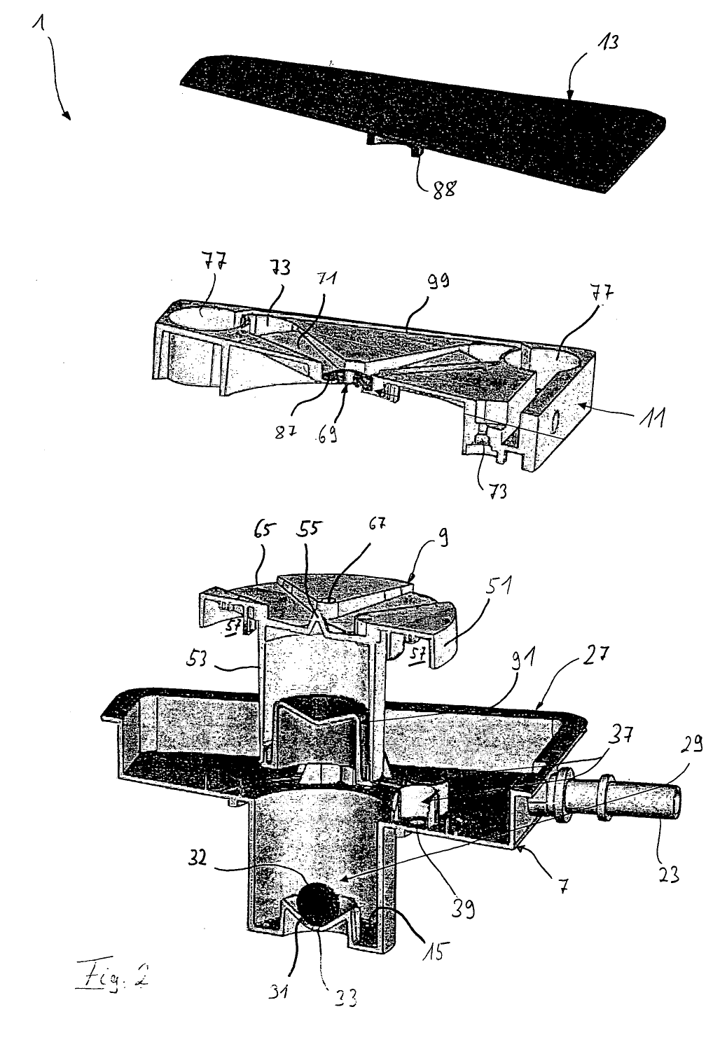

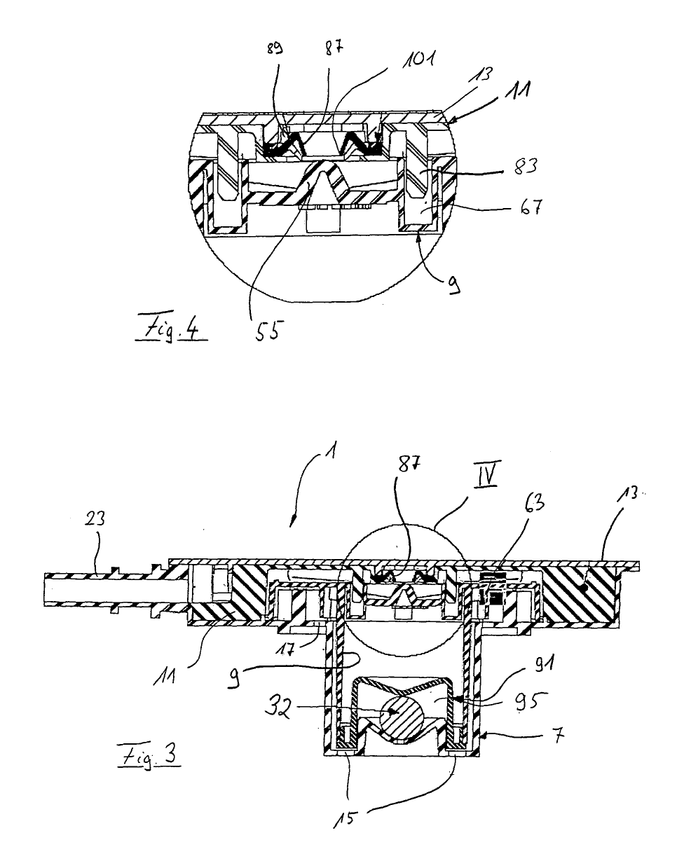

FIG. 3: a view in transverse section of the valve of FIGS. 1 and 2 when it is assembled;

FIG. 4: an enlarged view in transverse section of the zone IV of FIG. 3;

FIG. 5: a view in perspective of a closure element of the valve according to the invention;

FIG. 6: a plan view of the closure element of FIG. 5, when the margins and hidden edges situated on the lower side of the closure element are drawn by mixed lines;

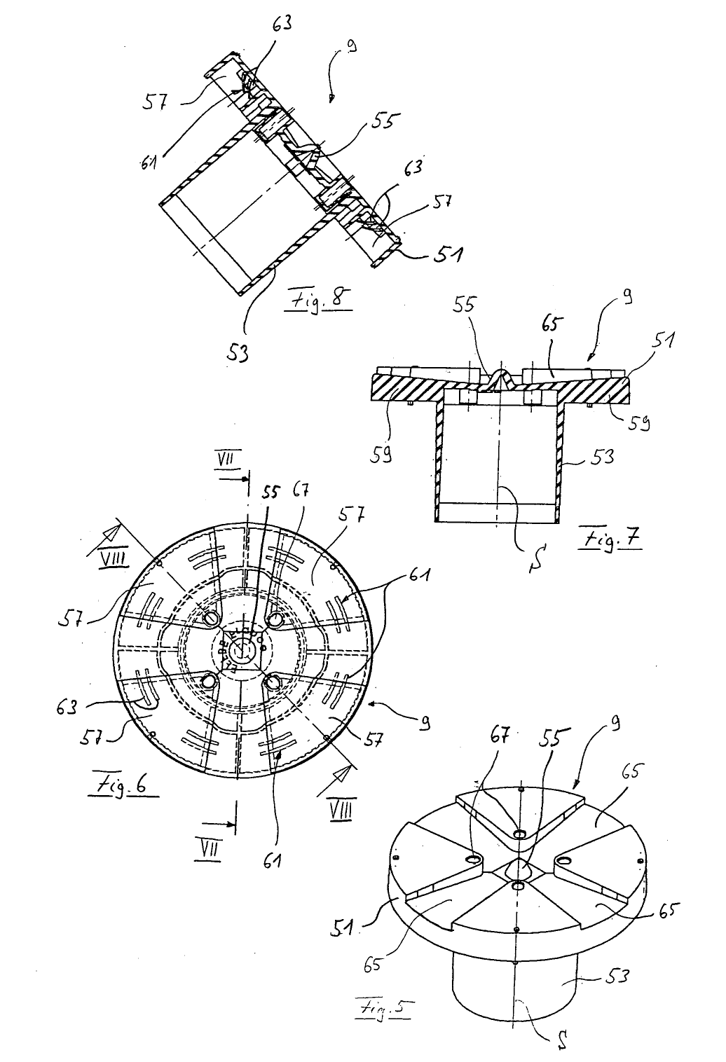

FIG. 7: a view in transverse section of the closure element along the section line VII-VII of FIG. 6;

FIG. 8: another view in transverse section of the closure element along the section line VIII-VIII of FIG. 6;

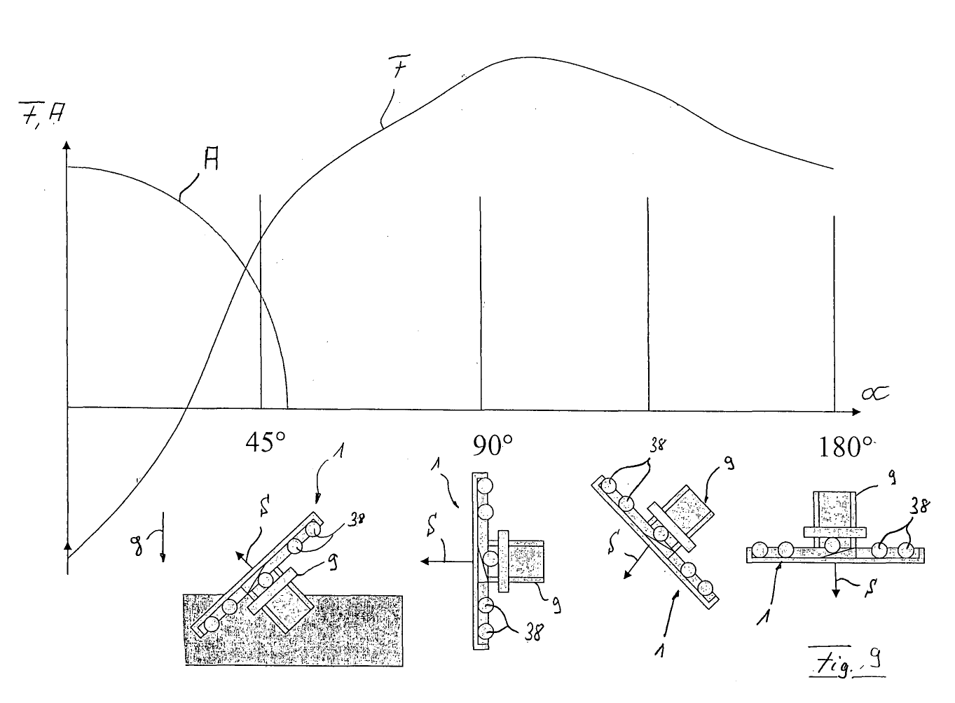

FIG. 9: shows a diagram which, for tilting positions of the valve in the three-dimensional volume with different angles of inclination α with respect to the direction of gravitation, represents the evolution of the value of the closure force which is transmitted by the actuator to the closure element;

FIG. 10: shows a plan view of an element which is a component of the valve which forms the passage opening to be closed by the closure element and which includes components of a device to produce a sharp drop (rapid rise ?) of the overpressure in the tank;

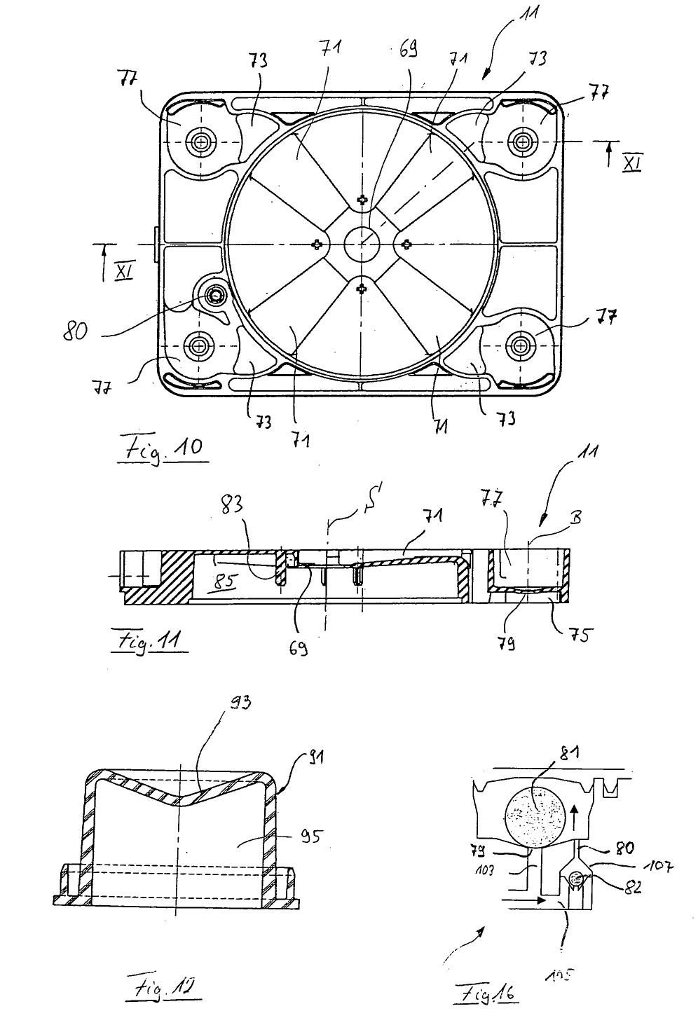

FIG. 11: shows a view in transverse section along the section line XI-XI of FIG. 10;

FIG. 12: shows a view in transverse section of a component of the valve which is to be connected with the closure element to delimit a volume serving to receive a metallic ball;

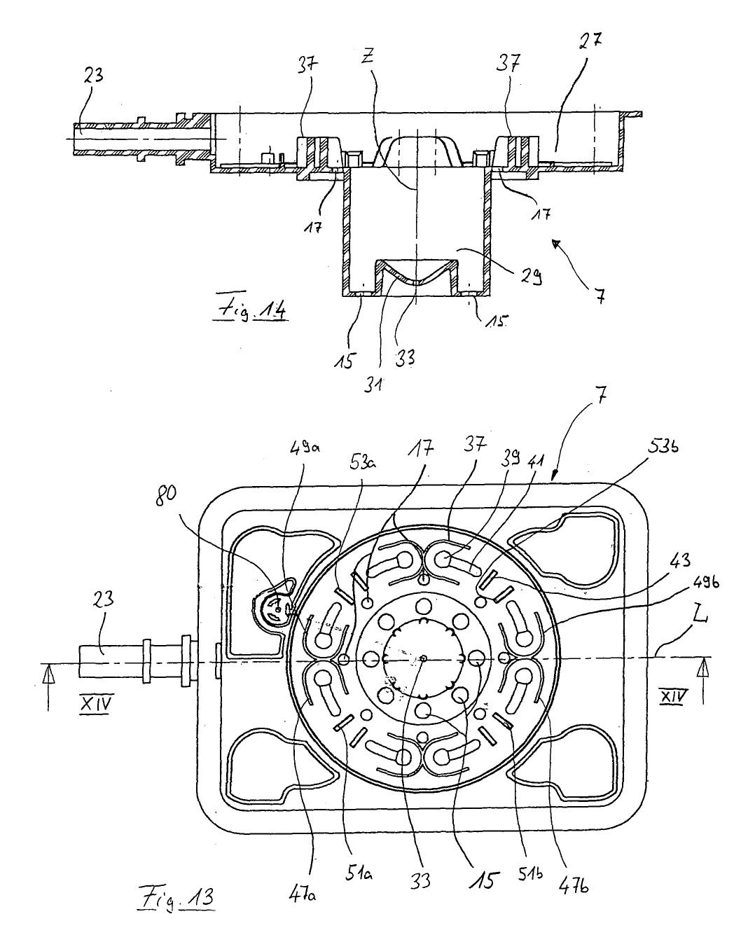

FIG. 13: shows a plan view on a valve case according to the invention;

FIG. 14: shows a view in transverse section of the case along the section line XIV-XIV of FIG. 13;

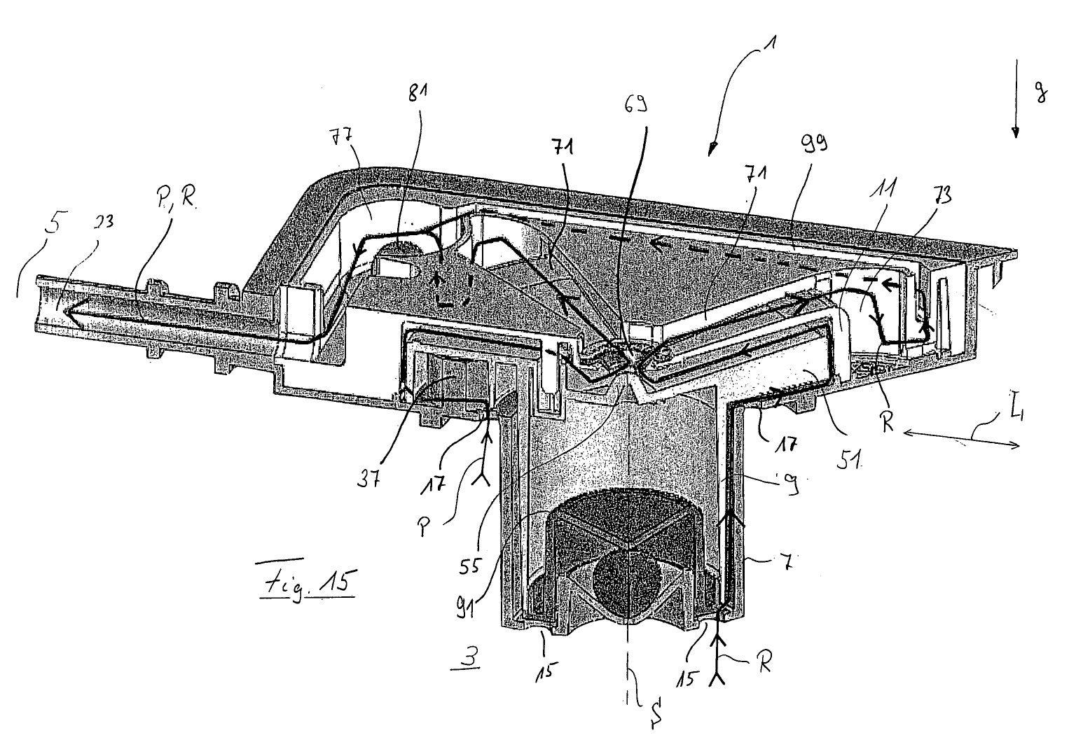

FIG. 15: shows a cut out perspective view of the valve according to the invention of FIGS. 1 to 3, two paths of an evacuation flow of gas being drawn in by arrows and

FIG. 16: shows a diagram of a device for producing a rapid rise of the overpressure in the tank.

In FIGS. 1, 2, 3, 4 and 15, the valve according to the invention for a fuel tank (not shown) of a motor vehicle (not shown) is marked by reference number 1. The valve 1 guarantees that a flow of gas is admitted between the interior 3 of the tank and the exterior 5 of the tank, when an evacuation flow of the liquid fuel (not shown) contained in the tank is to be avoided, by example in the case of excessive filling of the tank and in the case of inclined positions of the tank with inclination angles with respect to the direction of terrestrial gravitation being able to be up to 180°, therefore in the case of emergency situations of the motor vehicle which is lying on its side or on its roof in an accident. The valve 1 must in addition guarantee a flow of air from the exterior 5 of the tank towards the interior 3 of the tank, and this being in particular during the movement of the motor vehicle when liquid fuel is aspirated from the fuel tank and when the concern is with compensating a depression thus forming inside the tank.

In FIGS. 1 to 4, one can see the structure of the valve assembly according to the invention 1, which is composed substantially of four main components which can be made of injection moulded synthetic material and which are a case 7, a closure element 9 housed in a movable manner with respect to the case 7, an intermediate piece 11 housed in a fixed manner in the case 7 and a covering plate 13 covering the intermediate piece 11.

The case 7 is shown in detail in FIGS. 13 and 14 and defines several gas inputs 15 and 17 and a common gas output 23 in which all the fluid conduits terminate, extending through the valve 1. The gas output is configured as a connection serving to provide a link with a line for the entry and exit of gas.

The case 7 is composed of a first receiver surface 27 situated at the height of the output 23 and of a second receiver surface 29 which is situated beneath and which extends substantially to the centre of the case, deviating from the first receiver surface 27. The second receiver surface 29 comprises a hollow structure of cylindrical shape with a base in which the gas inputs 15 are situated, realized in the form of bores and on which is configured a housing in the form of a funnel 31 in which there is situated a metallic ball of greater mass (see FIGS. 2 and 3).

In a manner concentric to the axis Z of the cylinder of the second housing 29, a bore 33 is provided in the funnel-shaped housing 31, which bore is occupied by the metallic ball 32 in the case of a normal horizontal position of the valve or of the fuel tank, in which position the axis Z coincides substantially with the direction of gravitation.

The second receiver surface 29 is formed substantially by a flat and rectangular basin-shaped structure. According to a concentric arrangement around the axis Z of the cylinder, cylindrical housings 37 are configured which are open toward one side. Two cylindrical housings 37 touch each other on their closed sides. On the base of FIG. 13, two cylindrical housings which touch each other occupy positions at 12 o'clock, 3 o'clock, 6 o'clock and 9 o'clock. The cylindrical housings 37 open along the circular line on which they are situated. A pair of cylindrical housings is respectively essentially diametrically opposite to another having the same function, as the pairs of cylindrical housings 47a, 47b or 49a, 49b.

The cylindrical housing 37 serves to receive respectively a metallic ball 38 of less great mass (FIG. 1). To ensure an easier mounting, the base surface of the cylindrical housing 37 comprises a basin 39 in which the metallic ball 38 is held when the valve 1 is in the normal position and which is followed by a groove 41 extending in a concentric manner around the axis Z of the cylinder. When under the influence of the stress provided by its weight the metallic ball 38 rolls via the open side out of the cylindrical housing 37 towards an abutment 43, the groove 41 and the lateral walls of the cylindrical housing 37 guide this metallic ball 38 of less great mass over a predetermined cam path.

If the valve 1 is, for example, tilted about its longitudinal axis L (FIG. 13) and if this results in an angle of inclination between the direction of terrestrial gravitation g and the axis Z of the cylinder, the metallic balls of less great masses can move out of the cylindrical housings 47a, 47b or 49a, 49b and touch the abutments 51a, 51b or 53a, 53b.

FIGS. 5 to 8 show the closure element 9 of the valve 1 in detail. The closure element 9 comprises a substantially mushroom-shaped structure with a hat-shaped section 51 and hollow cylindrical stem section 53. The exterior diameter of the stem section 53 is adapted to an interior diameter of the second cylindrical receiving surface 29 of the case 7 in such a way that this section 53 can be introduced with an intermediate space in the case 7 (see FIG. 3). In the concentric direction with respect to the axis of symmetry S, a tightness section 55 is formed at the centre on the closure element 9, said section passing beyond in the form of a nose of a substantially horizontal exterior area of the hat-shaped section 51.

On the lower side, the hat-shaped section is provided with four free volume compartments 57 which are separated from each other by ribs 59. The compartments 57 serve to receive the cylindrical housing 37 of the case 7 and the respectively movable metallic ball 38 of less great mass. To form the cam path, a slope 61 realized by two rising ribs 63 is respectively integrated in a single piece in the form of the interior horizontal area of the compartments. In the mounted state, the gradient of the slope 61 increases in the course of the extension of the groove 41 from the basin 39 to the abutment 43.

On the upper side of the hat-shaped section 51 there is a cross-shaped arrangement of cutaway bands 65 which lead a flow of gas from the circular side of the hat-shaped section 51 up to the tightness section 55.

In addition, four guide bores 67 are configured concentrically to the axis of symmetry S on the upper side of the hat-shaped section 51. The guide bores 67 receive journals 83 situated on the lower side of the intermediate piece 11, thus ensuring a guided relative movement of the closure element 9 with respect to the intermediate piece 11. In the following text, details of the intermediate piece 11 are explained on the basis of FIGS. 10 and 11.

The intermediate piece 11 forms, in the direction concentric to the axis of symmetry S, a passage opening 69 in which all the fluid communication conduits between the gas inputs 15, 17 and the gas output 23 terminate, and which can be closed by the tightness section 55 of the closure element 9.

On the upper side of the intermediate piece 11, a cross-shaped arrangement of channels 71 is provided, which allows the circulation of the gas flowing through the passage opening 69 towards the zones of the angles of the intermediate piece. In the zones of the angles, a passage 73 is respectively realized, through which the gas can arrive in a zone situated on the lower side 75. Above the zone situated on the lower side 75, a cylindrical tank housing 77, on the base of which a bore 79 is configured concentrically to the axis B of the tank, is respectively provided at the four corners. In the four housings of the tank 77 there are arranged in a movable manner four metallic balls 81 of greater mass which, at least when the movement of the vehicle stops and when the valve 1 is in a horizontal position, occupy the bore 79 so as to ensure its tightness.

On the lower side of the intermediate piece 11, four journals 83, which extend parallel to the axis of symmetry S downwards and which, in the mounting state, penetrate in the guide bores 67 of the closure element 9, are formed in a single piece concentrically to the axis of symmetry S.

On the lower side of the intermediate piece 11 there is formed a hollow cylindrical cavity 85 in which the hat-shaped section 51 of the closure element 9 is adapted with play (see FIG. 3). As can be seen in FIG. 1, a flexible tightness ring 87, which guarantees a tight closure of the passage opening 69 in cooperation with the tightness section 55 of the closure element 9, is situated on the upper part of the passage opening 69 of the intermediate piece 11. A mounting ring 89 is arranged between the tightness ring 87 and the covering plate 13 to hold the tightness ring 87 in its position. The tightness ring 87 can be made from any material based on rubber or elastomers.

The covering plate 13 is realized in such a way that it closes the cutouts 71 and the cylindrical tank housings 77 so as to ensure their tightness and that with the aid of a flange 88 it pushes the tightness ring 87 against the edge of the passage opening.

In FIG. 12, an insert 91 is shown which can be introduced in a fixed manner from the open side of the stem section 53 of the closure element 9 in a joining fit. The insert 91 comprises a cylindrical structure with a hollow cavity provided with a central drop 93 which reduces its interior volume. In the mounted state according to FIGS. 3 and 15, the insert and the funnel-shaped housing 31 of the case 7 delimit a receiving compartment 95 for the metallic ball 32 of greater mass.

The mode of operation of the valve according to the invention 1 is described below in particular on the basis of FIGS. 3, 4 and 15.

In a situation of normal functioning of the fuel tank, i.e. in the horizontal position of the fuel tank, the position of the valve 1 is defined such that the longitudinal direction L is situated on the horizontal plane and the axis of symmetry S or the axis of the cylinder Z coincide substantially with the direction of gravitation g.

On filling of the fuel tank with liquid fuel, air and fuel vapours which must escape via the valve 1 from the interior 3 of the tank toward the exterior 5 of the tank, are constantly delivered to the interior of the tank as the level of the liquid rises. For this, the gas can, as indicated by the path of arrows R and P, penetrate at inputs 15 and 17 into the valve complex. From the input 15, the gas can flow upwards in a vertical direction along the intermediate space between the closure element 9 and the case 7 and arrives around the hat-shaped section 51 at the passage opening 69, being also guided by the lower side of the intermediate piece 11. According to the path of the gas according to the arrow P, gas already penetrates into the valve via the input 17 to the hat-shaped section 51 and arrives at the passage opening 69.

In the operating state shown in FIG. 15, the closure element 9 and hence the tightness section 55 are situated in a passive position in which gas can arrive at the upper side of the intermediate piece 11, passing through the passage opening 69. From the open passage opening 69, the gas flows along channels 71 up to passages 73 and arrives via cylindrical tank housings 77 through the bores 79 to the output 23. In addition, the gas arrives via a narrow bypass or diversion 80 (see FIGS. 1, 10, 13 and 16) of the lower face of the intermediate piece 11 to its upper face and to the output, without having to pass through the bores 79. The bypass 80 is narrower and it is able to be closed by a small valve ball (82, see FIG. 16). For the cylindrical tank housings 77 which are at a distance from the output 23, a link channel 99 is provided which connects the distant cylindrical tank housing 77 with the near cylindrical tank housing 77.

In a situation of emergency functioning of the motor vehicle, for example if the motor vehicle is inclined with respect to the horizontal, the valve according to the invention 1 guarantees that no liquid fuel can leave towards the gas output 23 via the fluid communication between the gas inputs 15 and 17. The automatic functioning mechanism for the separation of the fluid communication is realized by the low mass metallic balls 38, this being for an inclination of the tank or of the valve, above all with an angle of inclination around the direction of gravitation g of 5° to 90° when the metallic balls 38 fulfil the function of entrainment control for the control of the closure element 9 so as to move it from the open position shown in FIG. 15 to the closed position in which the tightness section 55 is moved by penetrating into the tightness ring 87, as a function of which the tightness lips 101 of the tightness ring 87 rest on the exterior side of the tightness section 55 so as to ensure its tightness (FIG. 4).

The control entrainment uses the stress provided by the weight of two metallic balls 38 in the case of an inclined position of the valve 1. With a corresponding inclination, the two metallic balls 38 determined by the position of the valve roll under the influence of the stress provided by the weight outside the cylindrical housing 37 up to the abutment 41, thus following the groove 39 on the cam path. On the path of the groove 39, the metallic ball 38 comes in contact with the slope 61, when the entrainment force due to the slope of the metallic ball causes a closure force, in cooperation with the slope 61, to move the closure element 9 in the direction of the axis of symmetry S (see also in FIG. 9 the small sketches of the valve). In the inclined state, two metallic balls 38 of less great masses, opposite each other, roll continuously towards the abutment 41, as a function of which the closure force, acting on the closure element 9, is doubled. The remaining metallic balls 38 stay in their starting position in the cylindrical housing 37.

The placement of eight metallic balls 38 of less great masses guarantees that, in each inclined position of the valve 1, a sufficient closure force is provided, i.e. by means of the movement of at least two metallic balls, to move the closure element 9 in the direction of the axis of symmetry S, so that the tightness section 55 comes in contact with the tightness ring 87 so as to ensure its tightness.

In the case of an inclination of the valve of 90° to 180° with respect to the direction of gravitation g, if as a consequence the motor vehicle is lying on its roof, the metallic ball of greater mass 32 produces in addition a closure force to close the passage opening 69 due to the fact that the mass of the metallic ball 32, by means of the insert 91 and metallic balls 38, pushes the closure element 9 against the passage opening 69. It should be noted that the stress provided by the weight of the metallic ball 32 is greater than the vertical thrust undergone by the closure element in the liquid fuel.

It is thus guaranteed that, in each emergency position with angles of 5° to 180° with respect to the direction of gravitation g, the nodal passage point, namely the passage opening 69, of the valve 1 is closed.

FIG. 9 shows the value of the closure force F as a function of the angular position of the valve 1 with respect to the direction of gravitation g. In the zone of an angular position of 0° to 45° and with a corresponding filling of the tank, it is above all vertical thrusts undergone by the closure element 9, the value of which is indicated by the curve A, which come into action.

As can be established, the closure force F acting on the closure element 9 and produced by the metallic balls 38 increases continuously with the increase of the inclination angle α (of 0° to 90°), this being because the pair of low mass metallic balls can, in the direction of symmetry S, exert reaction stresses on the closure element 9 which are all the greater, the greater the inclination of the valve.

The maximum closure force is reached around an angle of inclination of 90°. From 90°, the closure force F reduces slightly, but to the same extent according to which it has increased in the range extending from 45° to 90°. This is due to the metallic ball of greater mass 32 which causes the stress provided by its weight to act continuously more strongly in the inclination zones of 90° and 180°, the inclination zone in which the resultant closure force of the metallic ball 38 reduces.

The invention further concerns a device 101 to produce a rapid rise of overpressure in the tank. This rapid rise of overpressure can be detected by a pick-up situated on a distribution column of liquid fuel (not shown). By means of the signal from the pick-up, a control device commands the rapid stoppage of the filling operation with liquid fuel.

This device 101 for producing a rapid rise of overpressure in the tank is sketched diagrammatically in FIG. 16. The device 101 comprises five link conduits extending from the passage opening 69 to the output 23. Four of the link conduits 103 open into the bore 79, respectively, which is closed in a stop position of the vehicle by the metallic ball 81 of greater mass such that the total flow of gas is diverted in the fifth conduit, the bypass for the link conduits.

When the motor vehicle is travelling, the centrifugal forces acting on the metallic ball 81 cause the freeing of the bores 79 of the metallic ball 81 so that gas can pass in the tank and out of the tank through link conduits. The bypass 80 has a cone-shaped section in which a freely movable valve ball 82 is situated. In the case where an overpressure is formed due to the filling of the tank with fuel, the overpressure, when a first threshold is passed, overcomes the weight of the valve ball 82 such that gas can pass at the ball side 82 in the bypass 80 towards the output 23. When a second overpressure threshold is exceeded, a short time before the tank is completely filled, the valve ball 82 has access to the funnel zone 107 and closes the bypass 80. In this way, the emission of gas is interrupted and a rapid rise in overpressure is measurable.

The fact of distributing the device for producing a rapid rise in overpressure in the tank in four identical valve bodies in the form of metallic balls 81 allows a flat design form to be guaranteed.

The same thing is valid for the distribution in several pairs of metallic balls of less great mass of the control elements acting on the closure element 9, as a function of which the desired flat design of the valve 1 is possible and a greater filling volume is available for the tank.

The characteristics set forth in the above description, in the figures and in the claims can be important, both individually and in any combination, for the realization of the invention in its different arrangements.

Of course, the invention is not limited to the example embodiments described and shown above, from which one will be able to provide other modes and other forms of embodiment, without, however, departing from the framework of the invention.

### LIST OF REFERENCE NUMBERS

1 valve
3 interior of tank
5 exterior of tank
7 case
9 closure element
11 intermediate piece
13 covering plate
15, 17 inputs
23 output
27 first receiver surface
29 second receiver surface
31 funnel-shaped housing
32 metallic ball
33 bore
37 cylindrical housing
38 metallic ball
39 basin
41 groove
43 abutment
47a, 47b, 49a, 49b cylindrical housings
51a, 51b, 53a, 53b abutments
51 hat-shaped section
53 stem section
55 tightness section
57 compartments
59 grooves
61 slope
63 ribs
65 cutaway bands
67 guide bores
69 passage opening
71 channels
73 passage
75 zone on lower side
77 tank housing
79 bore
80 bypass
81 metallic ball
82 valve ball
83 journal
87 tightness ring
88 flange
89 mounting ring
91 insert
93 drop
95 receiving compartment
99 link channel
101 device to produce a rapid rise in overpressure
103 link conduits
107 funnel zone
B axis of tank
F closure force
g direction of gravitation
L longitudinal direction
R, P path of arrows
S axis of symmetry
Z axis of cylinder

1. A valve for a tank, in particular a fuel tank of a motor vehicle, with an input, an output and a fluid communication connecting the input and the output and serving for the flow out of the tank and/or in the tank of a fluid in gaseous state, such as air and/or a fuel in gaseous state, and with a mechanism for the separation of the fluid communication which can be activated depending on the position of the tank or of the valve (1) and which comprises at least one movable closure element (9) which can be moved between a passive open position and an active position which interrupts the fluid communication and in which a passage of a fluid, in particular at least of a liquid such as a liquid fuel, through the fluid communication is substantially interrupted, characterized in that the separation mechanism comprises at least one actuator which is structurally separated from said at least one closure element (9) and which can be activated in the three-dimensional volume as a function of the position of the tank or of the valve (1) to transmit to the closure element (9) a closure force serving to control or position the closure element (9) so as to move it from the passive position to the active position.

2. The valve according to claim 1, characterized in that several actuators are associated in such a way to a closure element (9) that, for respectively a predetermined position of the tank or of the valve (1) in the three-dimensional volume, at least one of the actuators, preferably two actuators, transmit(s) a closure force to the closure element (9).

3. The valve according to claim 2, characterized in that the several actuators are brought into accord with each other such that, for different predetermined positions of the tank or of the valve (1) in the three-dimensional volume, at least one actuator, preferably a pair of actuators, is activated, so that a closure force is transmitted to the closure element (9).

4. The valve according to any of claims 1 to 3, characterized in that, when the predetermined position is reached, the said at least one actuator transmits in an autonomous manner the closure force to the closure element.

5. The valve according to any of claims 1 to 4, characterized in that in a normal mode of operation in which the tank, in particular the motor vehicle, is in a substantially horizontal position, the said at least one actuator is deactivated and in that in an emergency mode of operation, in which the tank, in particular the motor vehicle, is in an oblique position substantially tilted and/or inclined with respect to the horizontal position, at least one actuator, preferably a pair of actuators, transmits to the closure element (9) a closure force to bring the closure element (9) into the active position.

6. The valve according to any of claims 1 to 5, characterized in that for a closure element (9) preferably at least two actuators are provided, preferably at least three actuators, preferably at least four actuators, preferably at least six actuators, preferably at least eight actuators, in particular nine actuators.

7. The valve according to any of claims 1 to 6, characterized in that, for an inclination of the valve or of the tank towards a vertical axis which is in particular directed in the direction parallel to the direction of terrestrial gravitation with an angle of inclination of 5° to 90° in all the horizontal directions, it is possible to activate a group of at least four actuators, preferably a group of four pairs of actuators, when at least one of the actuators, preferably one of the pairs of actuators, is activated, so that a closure force for the control of the closure element (9) so as to move it in the active position, is transferred to the closure element (9).

8. The valve according to any of claims 1 to 7, characterized in that, for an inclination of the valve or of the tank around a vertical axis which is in particular oriented parallel to the direction of terrestrial gravitation with an angle of inclination α of 90° to 180° in all the horizontal directions, at least two actuators are activated, so that a closure force for the control of the closure element (9) so as to move it to the active position is transferred to the closure element (9).

9. The valve according to any of claims 1 to 8, characterized in that the said at least one actuator is formed, in particular for an inclination with an angle α of 5° to 90° around a vertical axis, by at least one movable metallic ball (38, 32) preferably by a pair of movable metallic balls, which metallic ball (38, 32), when the valve is inclined, is guided under the influence of the stress provided by its weight along a cam path from a position of rest to an entrainment position such that the metallic ball (38, 32) provides on the passage of the cam path a closure force to the closure element (9).

10. The valve according to claim 9, characterized in that at least one part of the cam path is formed by the closure element (9) which assigns a starting slope (61) to each metallic ball (38).

11. The valve according to claim 9 or 10, characterized in that the at least one metallic ball (3 8) is housed in a movable manner in a valve case (7) which delimits the cam path.

12. The valve according to any of claims 1 to 11, characterized in that a single closure element (9) is provided, which is housed in a movable manner in a valve case (7).

13. The valve according to any of claims 1 to 12, characterized in that a main passage opening (69) is provided, through which all the communication lines extend from the input to the output.

14. The valve according to any of claims 1 to 13, characterized in that the at least one closure element (9) comprises a tightness section (55) which, in the active position, is formed for the closure of a passage opening (69) of the fluid communication, which passage opening (69) is configured in particular in a valve case (7) containing the closure element (9) in a movable manner.

15. The valve according to any of claims 1 to 14, characterized in that in the zone of the passage opening (69) a flexible tightness ring (87) is provided, which receives the tightness section (55), forming a tightness surface extending substantially over the entire periphery.

16. The valve according to any of claims 1 to 15, characterized in that the said at least one closure element (9) is configured as a floating body for a liquid contained in the tank.

17. The valve according to any of claims 1 to 16 or according to the preamble of claim 1, characterized in that it is intended to be mounted in a fuel tank of a motor vehicle and comprises a device for producing a rapid rise in overpressure in the tank, which device comprises a group of at least two valve bodies which, at least when the vehicle is in a stop position, in order to ensure its tightness, occupy respectively a passage in the fluid link formed by a valve case (7), and a valve element to occupy a bypass (80) in the fluid communication formed by the valve case, the valve element being adjusted in such a way as regards its weight that in the case of exceeding an overpressure being able to be determined inside the tank, it occupies the bypass.

18. The valve according to claim 17, characterized in that the at least two valve bodies are formed by metallic balls (81) having substantially identical masses.

19. The valve according to claim 17 or 18, characterized in that four valve bodies are assigned to four passages.
